(19) United States
(12) Patent Application Publication
(10) Pub. No.: US 2023/0374292 A1
(43) Pub. Date: Nov. 23, 2023

(54) FOOD CONTACT SAFE, GERM REPELLENT MATERIAL

(71) Applicant: Nano and Advanced Materials Institute Limited, Hong Kong (HK)

(72) Inventors: Wenjun MENG, Hong Kong (HK); Wai Hong YU, Hong Kong (HK); Mingyu ZHANG, Hong Kong (HK); Wing Hin LEUNG, Hong Kong (HK); Yueying CHEN, Hong Kong (HK)

(21) Appl. No.: 18/258,563

(22) PCT Filed: Dec. 22, 2021
(86) PCT No.: PCT/CN2021/140641

§ 371 Date: Jun. 21, 2023

Related U.S. Application Data
(60) Provisional application No. 63/129,616, filed on Dec. 23, 2020.

(51) Int. Cl. C08L 67/02; B65D 65/42; B65D 81/28; B29C 43/00; C08L 23/12; C08L 83/04; C08K 5/101; C08K 3/36; C08J 3/22; A01N 25/10; A01P 1/00; A01P 3/00; A01N 31/02; A01N 37/06; A01N 55/00

(52) U.S. Cl. CPC C08L 67/02; B65D 65/42; B65D 81/28; B29C 43/003; C08L 23/12; C08L 83/04; C08K 5/101; C08K 3/36; C08J 3/226; A01N 25/10; A01P 1/00; A01P 3/00; A01N 31/02; A01N 37/06; A01N 55/00; B29K 2083/00

(57) ABSTRACT

A food contact safe, germ repellent plastic selected from modified thermoplastic, vulcanized silicone rubber or modified base plastic. The plastic includes an anti-biofouling agent at approximately 1 to 20 wt. % to the total weight of the plastic; and one or more components of fillers, carrier agent, mold releasing agent, curing agent, and/or oil, at approximately 0.1 to 2 wt. % for each or more of the components to the total weight of the plastic, where the anti-biofouling agent forming a hydration layer on the plastic imparts germ repellency against bacteria including Escherichia coli and Staphylococcus aureus while optical and mechanical properties including transmittance, tensile strength, impact strength, hardness, and/or heat deflection temperature of the plastic is/are changed by less than 10% after being associated with the anti-biofouling agent and the one or more of the components other than the anti-biofouling agent.

### CROSS-REFERENCE TO RELATED APPLICATION

This application claims priority from the U.S. provisional patent application No. 63/129,616 filed Dec. 23, 2020, and the disclosure of which is incorporated herein by reference in its entirety.

### TECHNICAL FIELD

The present invention relates to a food contact safe, germ repellent material.

### BACKGROUND

Plastic is one of the food contact materials (FCMs) for making food contact articles (FCAs) used in production, processing, transport, handling and storage of food. However, plastic surfaces are a potential site for bacterial growth and a bacteria-populated slimy film, called biofilm, tends to develop thereon. Biofilms present a health hazard to humans and increases the chance of microbial infections.

Introduction of biocides or antimicrobial agents to the plastic surface, e.g., introducing heavy metal such as silver and/or its derivatives by binding the same to the plastic surface through chemical or irradiation treatment is not considered as food contact safe. A safe, non-leaching, biocide-free solution to make plastic surface resistant to bacterial growth by preventing its adhesion and colonization is one of the alternatives to the biocides or bacteria-killing actives which could be considered as plastic for food contact but should still have to comply with the corresponding regulations of food contact materials.

Most of the existing non-leaching, biocide-free solutions to make a plastic surface resistant to adhesion and colonization of bacteria function by introducing a hydrophilic layer via physical, chemical or covalent attachment to the target plastic before or during extrusion of the plastic. Some known hydrophilic agents or additives forming such a hydrophilic layer on the plastic include poly(ethylene glycol) (PEG), chitosan, polycations, and zwitterionic polymers. The hydrophilic layer exhibits anti-fouling effect on non-specific adhesion and potential colonization of bacterial growth on a plastic surface.

The following problems exist when using the conventional Germ-Repellent modification methods:
1) Change of the physical properties (e.g. mechanical properties, transparency and HDT of the modified PCT; mechanical properties of PP, hardness of silicone);
2) It is hard to select a matching hydrophilic agent to the plastic of interest due to other external factors such as the manufacturing limitations that may restrict the use of some hydrophilic agents, e.g., an unmatched hydrophilic agent can always lead to slipping at the screw surface during the manufacturing (for modified PCT and PP);
3) It is impossible to directly mix the silicone rubber with the hydrophilic agent in the two-roll milling process. The silicon oxide nanoparticles help with the mixing of the antifouling agents and the raw rubber.

### SUMMARY OF THE INVENTION

In view of the foregoing problem, a first aspect of the present invention provides a food contact safe, germ repellent material selected from a thermoplastic or elastomer, and the material comprises:
one or more anti-biofouling agents at approximately 0.1 to 20 wt. % to the total weight of the plastic; and
one or more components of fillers, carrier agent, mold releasing agent, curing agent, and/or oil, at approximately 0.1 to 2 wt. % for each or more of the components to the total weight of the plastic,
the one or more anti-biofouling agents forming a hydration layer on the plastic imparting germ repellency of at least 92.1% against bacteria including Escherichia coli and Staphylococcus aureus while optical and mechanical properties including transmittance, tensile strength, impact strength, hardness, and/or heat deflection temperature of the plastic is/are changed by less than 10% after being associated with the anti-biofouling agent and the one or more of the components other than the anti-biofouling agent.

In a first embodiment, the thermoplastic is selected from modified polycyclohexylenedimethylene terephthalate (modified PCT) or polypropylene (PP), and copolymer thereof. More specifically, the copolymer of polypropylene includes polypropylene impact copolymer (PPIC).

The one or more anti-biofouling agents can be one or more selected from polyol and derivatives thereof. More specifically, the one or more anti-biofouling agents include polyethylene glycol sorbitan monolaurate, polyethylene glycol sorbitan monooleate, poly(ethylene glycol) sorbitol hexaoleate, ceteareth-20, poly (ethylene glycol) distearate, poly (ethylene glycol) dimethicone, poly(ethylene oxide)-poly(propylene oxide)-poly(ethylene oxide), poly(ethylene glycol)-block-poly(propylene glycol)-block-poly(ethylene glycol), polyoxypropylene glycerol ether, and alkyl polyglycol ether.

The alkyl polyglycol ether can be represented by the following formula:

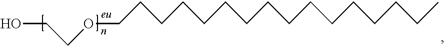

wherein n is an integer from 16 to 18.

The poly(ethylene glycol) sorbitol hexaoleate can be represented by the following formula:

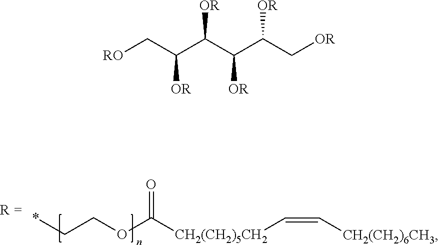

wherein n is an integer from 6 to 9

The polyethylene glycol sorbitan monooleate can be represented by the following formula:

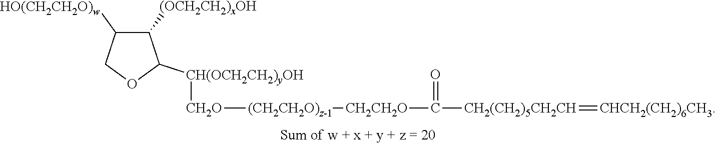

The poly(ethylene oxide)-poly(propylene oxide)-poly(ethylene oxide) can be represented by the following formula:

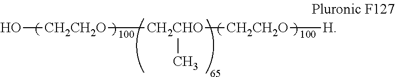

The poly (ethylene glycol) distearate can be represented by the following formula:

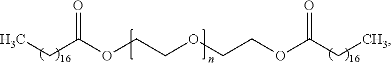

wherein n is an integer of 8 or 150.

The polyoxypropylene glycerol ether can be represented by the following formula:

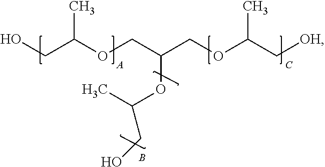

wherein sum of A+B+C=46 to 54.

The poly (ethylene glycol) dimethicone can be represented by the following formula:

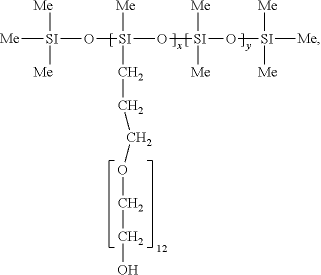

wherein sum of x and y is equal to a hydrophilic-lipophilic balance (HLB) number thereof, and the hydrophilic-lipophilic balance (HLB) number is 12.

The one or more anti-biofouling agents can be at approximately 0.1 to 10 wt. %.

The fillers in the first embodiment are reinforcing fillers comprising one or more types of nano-sized inorganic particles.

The inorganic particles as the fillers in the first embodiment are at approximately 0.1 to 1 wt. %.

The inorganic particles as the fillers in the first embodiment include fumed silica treated with any one of hexamethyldisilazane, dimethylpolysiloxane, and polydimethylsiloxane.

The carrier agent in the first embodiment is represented by the following formula:

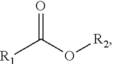

wherein R₁ and R₂ are independently hydrocarbon moieties and each of the hydrocarbon moieties comprises about 10 to 30 carbon atoms with linear or branched chain.

More specifically, the carrier agent is at approximately 0.1 to 1 wt. %.

In addition, the carrier agent in the first embodiment comprises stearyl palmitate, stearyl behenate, stearyl stearate, palmityl palmitate, myristyl palmitate, and myristyl myristate.

In a second embodiment, the elastomer is high consistency rubber.

The fillers in the second embodiment include silica.

The oil in the second embodiment can be a silicone oil including hydroxyl silicone oil.

The one or more anti-biofouling agents in the second embodiment include one or more polyethylene glycol and fatty acid moieties.

More specifically, the one or more anti-biofouling agents include polyethylene glycol fatty acid ester, polyoxyethylene lauryl ether, polyethylene glycol dimethicone, trimethoxysilyl propoxy polyethylene oxide methyl ether, and polyethylene glycol distearate.

The curing agent in the second embodiment can be 2,4-dichlorobenzoyl peroxide and/or di-tert-butyl 1,1,4,4-tetramethyltetramethylene diperoxide

There is provided a food contact article comprising the material of any one of the embodiments of the present invention.

A second aspect of the present invention provides methods for preparing the food contact safe, germ repellent material of the present invention.

In a first embodiment, the method for preparing the food contact safe, germ repellent material from thermoplastics selected from modified polycyclohexylenedimethylene terephthalate or polypropylene includes:
preparing a masterbatch comprising comingling the modified polycyclohexylenedimethylene terephthalate or polypropylene, and copolymer thereof, with the one or more anti-biofouling agents and the one or more components of fillers, carrier agent, mold releasing agent, curing agent, and/or oil;
adding the masterbatch into one of the thermoplastics at 1 to 25 weight percent for molding.

In a second embodiment, the method for preparing the food contact safe, germ repellent material from elastomers includes:
mixing raw silicone rubber, the one or more anti-biofouling agents, the fillers (e.g., silica) and carrier (vulcanizing) agent in a two-roll mill to form a mixture;
compression molding the mixture for vulcanization to obtain a vulcanized silicone rubber;
heating the vulcanized silicone rubber in an oven for post-vulcanization to obtain the elastomer.

### BRIEF DESCRIPTION OF THE DRAWINGS

The disclosure will become more fully understood from the detailed description given herein below for illustration only, and thus not limitative of the disclosure, wherein:

FIG. 1 is a schematic diagram depicting an embodiment of the present invention involving the use of a processing aid to assist the orientation of hydrophilic moiety of the hydrophilic additives to the surface of the base plastic from molten phase to liquid state followed by cooling stage after extrusion.

FIG. 2 illustrates schematically a typical example of a twin-screw extrusion process of preparing a germ-repellent polymer structure from base resin with germ-repellent modifiers according to an embodiment of the present invention.

FIGS. 3A, 3B and 3C illustrate a process workflow of how to conduct a germ repellent efficiency test for plastic samples made in (FIG. 3A) bottle preform; (FIG. 3B) lid; and (FIG. 3C) nozzle.

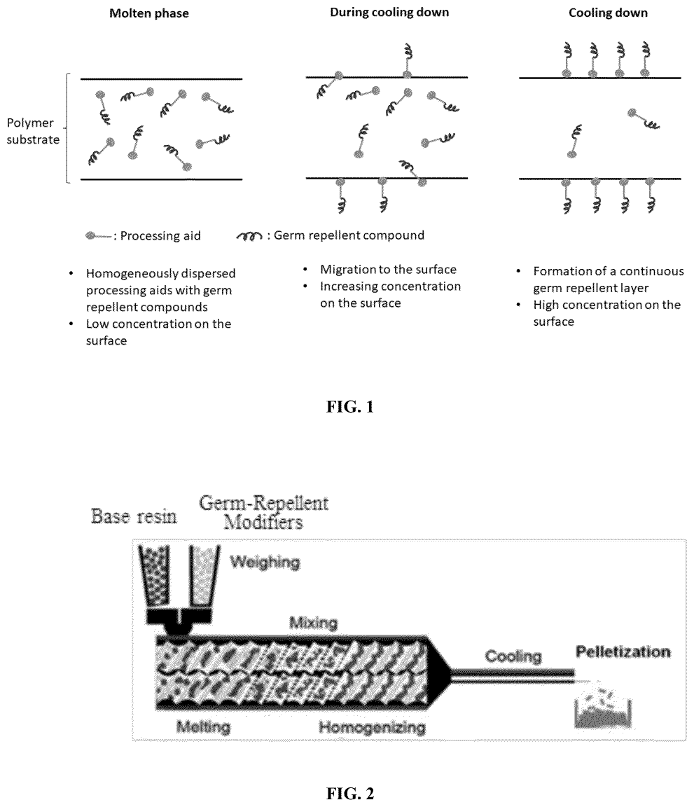

### DETAILED DESCRIPTION

The present invention will be described in detail through the following embodiments/examples with appending drawings. It should be understood that the specific embodiments are provided for an illustrative purpose only, and should not be interpreted in a limiting manner.

### EXAMPLES

Swab Test to Evaluate Germ Repellency of Plastic

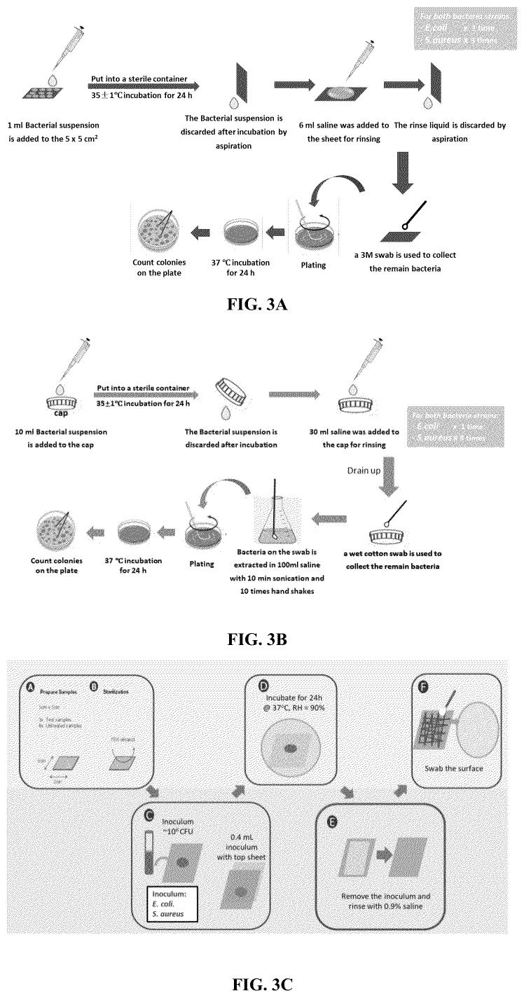

A swab test to evaluate the germ repellent efficacy is conducted on both samples by the following protocol. The germ repellent efficacy or germ repellency of a plastic can be determined by the amount of bacterial adhesion on samples fabricated from germ repellent base plastic blend compared to the base plastic without any germ repellent additives. Plastic samples are prepared in sheet in specific dimensions and first incubated for a fixed period of time against inoculums containing a known cell number of bacteria. The inoculum preparation and the bacterial incubation procedures follow the experimental protocol of industrial standards JIS Z 2801 or ISO 22196, whereby the test and the control work pieces are incubated at 37° C.±1° C. and relative humidity of not less than 90% for 24 h±1 h. One Gram-positive bacteria strain (e.g. Staphylococcus aureus) and one Gram-negative bacteria strain (e.g. Escherichia coli) are used as representative test microbes as outlined in the said standard. After incubation, the sample will undergo a bacteria clearance step by draining off the test inoculums from the samples, rinsing, and serially diluting with 0.9% saline solution to completely remove the inoculums. The adherent bacteria from the sample surfaces are collected by swab applicator and the collected bacteria will be representative of the species conductive to colonization and biofilm growth. After serial dilution, the collected bacteria will then be cultivated onto agar plates in standard 90 mm diameter Petri dishes and their cell viability are quantified in terms of colony forming units per specimen. FIG. 3 illustrates the process workflow of an in-house germ repellent efficiency test.

In general, a number of 4 cm×4 cm or 5 cm×5 cm replicates of each sample is prepared. Bacterial suspension solutions for both S. aureus and E. coli are prepared. 0.4 or 1 mL of each bacterial suspension is inoculated on the surface of three replicates of each plastic sample. The inoculated samples are incubated at 37° C. for 24 hours for S. aureus and 24-48 hours for E. coli. Afterwards, the samples are retrieved and washed with 8 mL saline. Samples inoculated with S. aureus are washed three times; samples inoculated with E. coli, one time. A 3M swab is used to collect remaining surface bacteria. The contents of the swab are plated on agar plates and incubated at 37° C. for 24 hours. Colonies formed on the agar plate after incubation are then counted.

Germ repellency in terms of the inhibition of bacterial colony formation unit (CFU) of the modified PCT against E. coli and S. aureus are 94.4% and 92.1%, respectively; germ repellency of the modified PP against E. coli and S. aureus are 96.1% and 99.9%, respectively; the germ repellency of the modified silicone rubber against E. coli and S. aureus are both 99.9%.

The following series of tests are intended to show that the mechanical, physical and/or optical properties of the plastic after said incorporation with the anti-biofouling agents and other components according to certain embodiments of the present invention are not substantially changed, e.g., within 10% of the original.

### Example 1—Germ-Repellent Modified Polycyclohexylenedimethylene Terephthalate (Modified PCT or “Tritan”) Plastics

100 g of an modified PCT (Tritan) basic plastic is comingled with 4 g of an myristyl palmitate carrier agent in the presence of 8 g of ceteareth and 8 g of poly(ethylene glycol) sorbitol hexaoleate as anti-biofouling compounds with 1 g fumed silica to form a masterbatch. The masterbatch is combined with the basic plastic at a weight ratio of 1:9 and subject to injection molding at a temperature from 220° C. in the front to 275° C. in the back when preparing the germ repellent plastic bottle preform. The preform is blow-molded to become a drinking bottle.

The drinking bottle is subject to a swab test (described hereinbefore) to compare the germ repellency of the germ-repellent plastic (A1) with that of a comparative plastic (Control). The results on the reduction of colony formation units of E. coli and S. aureus on the bottle samples made by different plastics are shown in Table 1.

In addition, two other samples to be fabricated into a 4 cm×4 cm sheet specimen, namely A2 and A3, respectively, which are also based on a germ-repellent Tritan modified by anti-biofouling compound(s) and one or more additives are tested with their germ repellency based on the same swab test protocol. Samples A2 and A3 are prepared from injection molding Tritan with two different masterbatches to form the sheet specimen, where Tritan:masterbatch in sample A2 is 1:7 while Tritan:masterbatch in sample A3 is 1:4; and the masterbatch for preparing sample A2 contains Tritan, 2 phr Croda Incromax® 100, 4 phr Eumulgin B2, 0.5 phr Aerosil® R8200 and 4 phr poly(ethylene oxide)-poly(propylene oxide)-poly(ethylene oxide) (“Pluronic F127”); the masterbatch for preparing sample A3 contains Tritan, 2 phr Croda Incromax® 100, 4 phr Atlas G1096, 4 phr Eumulgin B2 and 0.5 phr Aerosil® R8200. Their corresponding germ repellency against S. aureus and E. coli is also summarized in Table 1.

TABLE 1

| Sample Name | S. aureus | E. coli |
|---|---|---|
| A1 | 99.9% | 93.6% |
| A2 | 99.9% | 69.9% |
| A3 | 99.9% | 96.4% |

As can be seen in Table 1, with E. coli, the germ-repellent plastic sample A1 fabricated as a drinking bottle form of the present invention provides a 93.6% reduction in the swab test as compared to the comparative plastic (Control). With S. aureus, the germ-repellent plastic sample A1 of the present invention provides above 99.9% reduction in the swab test as compared to the comparative plastic (Control). Samples A2 and A3 fabricated as a plastic sheet form also exhibit similar germ repellency against S. aureus. However, sample A2 does not exhibit a satisfactory germ repellency against E. coli whereas sample A3 does, and has the highest against E. coli among the three samples. From these results, it is observed that germ-repellent plastic sample A1, i.e., Tritan modified with a carrier agent, two anti-biofouling compounds and a filler, exhibits high germ repellency against both E. coli and S. aureus, especially against S. aureus which is up to 99.9%_reduction; sample A3 with two other anti-biofouling compounds and other additives including a slip additive also exhibits high germ repellency against both bacterial strains. Furthermore, the bottle of germ-repellent plastic sample A1 passed the commission regulation EU No 10/2011 evaluation (overall migration and heavy metal) test and LFGB sensorial examination—odor and taste test.

Tensile Strength Test Result of Germ Repellent Tritan Sample A1

For the evaluation of the tensile strength of the plastic sample A1, standard dumbbell-shaped test specimens are prepared by a specimen cutter, e.g., SDL-200HC2 specimen cutter, from specimen sheet produced via single-screw extruder. The tensile strength at yield (MPa) is evaluated, which indicates the maximum load the specimen can withstand before permanent deformation. On the stress vs. strain curve, it is shown as the tensile stress at its first peak. The tensile strength of formulations is tested by MTS® 314 Electromechanical Universal Test system under the standard of ASTM D638 “Standard Test Method for Tensile Properties of Plastics.” The Young's modulus and maximum elongation can be determined from the stress-strain curves generated. Samples are loaded onto the grips using a gauge length of 12 mm. The samples are strained at a rate of 6 mm/minute for ABS.

TABLE 2

Tensile strength (Mpa)

| | Comparative plastic | Germ-repellent plastic |
|---|---|---|
| Replicate No. | (Control) | (A1) |
| 1 | 50.2 | 52.5 |
| 2 | 50.8 | 54.7 |
| 3 | 51.8 | 54.5 |
| 4 | 54.7 | 51.2 |
| 5 | 56.6 | 53.6 |
| Avg. | 52.8 | (+0.9%) |

From the results of Table 2, the incorporation of 0.8 wt. % of ceteareth and poly(ethylene glycol) sorbitol hexaoleate into Tritan does not substantially affect the tensile strength of the plastic, meaning that the polymer matrix of Tritan still remains intact as its original state without said incorporation.

Impact Strength Test Result of Germ Repellent Tritan Sample A1

The determination of the impact strength of the germ-repellent plastic is based on the standard and experimental protocol of ASTM D-256 “Standard Test Methods for Determining the Izod Pendulum Impact Resistance of Plastics.” Plastic bar specimens with specific dimensions are prepared by injection moulding machine (Thermo Scientific™, MiniJet). Then, a notch is made at a specified location on each of the plastic bar specimen. The impact strength is determined from the resistance of the plastic samples to a standardized pendulum-type hammer, mounted on a standardized machine (also called Kunlun impact tester), to breaking from a single swing. The Izod impact strength was characterized by Kunlun impact tester according to ASTM D256-10 with impact energy 5.5 J.

TABLE 3

Impact strength (J/m)

| | Comparative plastic | Germ-repellent plastic |
|---|---|---|
| Replicate No. | (Control) | (A1) |
| 1 | 998.2 | 973.9 |
| 2 | 942.1 | 913.3 |
| 3 | 960.4 | 941.3 |
| 4 | 968.5 | 961.1 |
| 5 | 971.2 | 956.9 |
| Avg. | 968.1 | 949.3 (−2.0%) |

From the results of Table 3, the incorporation of 0.8 wt. % of ceteareth and poly(ethylene glycol) sorbitol hexaoleate into Tritan does not substantially affect the impact strength of the plastic, meaning that the polymer matrix of Tritan still remains intact as its original state without said incorporation.

Heat Deflection Temperature Test Result of Germ Repellent Tritan Sample A1

The heat deflection temperature is determined using ISO 75. The plastic is molded to a bar with size 80 mm×10 mm×4 mm. The bar specimen is placed under the deflection measuring device (JJ Tester). A load of 0.45 MPa is placed on each specimen. The specimen is then sunk into a silicone oil bath where the temperature is raised at 2° C. per minute until they deflect 0.32 mm flatwise.

TABLE 4

Heat deflection temperature (° C.)

| | Comparative plastic | Germ-repellent plastic |
|---|---|---|
| Replicate No. | (Control) | (A1) |
| 1 | 95.3 | 89.6 |
| 2 | 93.1 | 88.4 |
| 3 | 93.0 | 91.9 |
| Avg. | 93.8 | 89.9 (−3.9%) |

From the results of Table 4, the incorporation of 0.8 wt. % of ceteareth and poly(ethylene glycol) sorbitol hexaoleate into Tritan does not substantially affect the heat deflection temperature (deformation temperature under specific load) of the plastic, meaning that the polymer matrix of Tritan still remains intact as its original state without said incorporation.

Transmittance Test Result of Germ Repellent Tritan Sample A1

Transmittance is characterized as complied with ASTM D1003 Procedure A. The plastic specimen is cut into a disk with 50 mm in diameter, or a square with sides of the same dimensions. The specimen should have substantially plane-parallel surfaces free of dust, grease, scratches, and blemishes. The transmittance (%) of specimen is measured using GW-820 automatic Haze measurement meter.

TABLE 5

Transmittance (%)

| | Comparative plastic | Germ-repellent plastic |
|---|---|---|
| Replicate No. | (Control) | (A1) |
| 1 | 86.3 | 84.0 |
| 2 | 87.6 | 85.9 |
| 3 | 86.3 | 85.4 |
| Avg. | 86.7 | 85.1 (−1.8%) |

From the results of Table 5, the incorporation of 0.8 wt. % of ceteareth and poly(ethylene glycol) sorbitol hexaoleate into Tritan does not substantially affect the transmittance of the plastic, meaning that the polymer matrix of Tritan still remains transparency as its original state without said incorporation.

### Example 2—Germ-Repellent Polypropylene (PP) Plastics

The masterbatch is prepared by comingling 90 g of PP basic plastic with 5 g of a polyoxypropylene glyceryl ether and 5 g of a poly (ethylene glycol) distearate as anti-biofouling compounds in a twin-screw extruder to form a masterbatch. The twin-screw extruder has a temperature range from 180° C. in the front to 210° C. in the back.

The masterbatch and the basic plastic are comingled to form germ-repellent plastic sample B1. Specifically, the plastic sample B1 is injection molded in an injection molding machine to generate lids of sample B1 at a temperature ranging from 190° C. in the front to 225° C. in the back. The basic plastic and the masterbatch are at a weight ratio of 9:1.

Comparative plastic samples (Control) containing only the basic plastic (PP) is also prepared in an identical manner, except neither masterbatch nor anti-biofouling compound is included.

A swab test is conducted to compare germ repellency of the germ-repellent plastic samples (B1) with that of the comparative plastic samples (Control). The results on the reduction of colony formation units of E. coli and S. aureus on the lid samples made by different plastics are shown in Table 6.

In addition, two other samples, B2 and B3, respectively, prepared based on polypropylene impact copolymer (PPIC) incorporated with one or more anti-biofouling agents including polyoxypropylene glycerol ether (“GP-330”), polyoxypropylene (30) glycol (“Kolliphor® P188”) and that/those used in the sample B1. Other possible anti-biofouling agents include polyoxyl 40 hydrogenated castor oil (“Kolliphor® RH40”). Sample B2 is fabricated as a bottle cap form whereas sample B3 is fabricated as a 4 cm×4 cm sheet form when being subjected to swab test and other mechanical property tests, if any. In one embodiment, a masterbatch of PPIC, the one or more anti-biofouling agents, and other additives in a ratio of about 18:1:1 is prepared, followed by injection molding the PPIC and the masterbatch in a ratio of about 9:1 in order to prepare samples B2 and B3.

TABLE 6

| Sample Name | S. aureus | E. coli |
|---|---|---|
| B1 | 99.9% | 98.5% |
| B2 | 99.9% | 93.6% |
| B3 | 96.9% | 93.4% |

As can be seen in Table 6, with E. coli, the germ-repellent plastic (B1) of the present invention provides a 98.5% reduction in the swab test as compared to the comparative plastic (Control); with S. aureus, the germ-repellent plastic (B1) of the present invention provides above 99.9% reduction in the swab test as compared to the comparative plastic (Control). Compared to sample B1, samples B2 and B3 also exhibit similar germ repellency against S. aureus to that of sample B1; a slightly lower germ repellency against E. coli than that of sample B1. From these results, it can be observed that the PP modified with the anti-biofouling compounds exhibits high germ repellency against both E. coli and S. aureus, especially S. aureus. Furthermore, the lid made of germ-repellent plastic B1 passed the commission regulation EU No 10/2011 (overall migration and heavy metal) and US FDA 21 CFR 177.1520 (olefin polymers) food contact safety test. Moreover, the lid also passed LFGB sensorial examination—odor and taste test.

Tensile Strength Test Result of Germ Repellent PP

As in Example 1, ASTM D638-10 Type VI specimens of PP and germ repellent PP were prepared by Dumbbell Cutter and tested by MTS under speed of 10 mm/min.

TABLE 7

| | Tensile strength (Mpa) | |
|---|---|---|
| | Comparative plastic | |
| Sample name | (Control) | Germ-repellent plastic (B1) |
| 1 | 31.7 | 31.0 |
| 2 | 31.9 | 32.3 |
| 3 | 32.1 | 33.9 |
| 4 | 32.0 | 32.2 |
| 5 | 32.8 | 32.5 |
| Avg. | 32.1 | 32.4 (+0.9%) |

From the results of Table 7, the incorporation of 0.56 wt. % of polyoxypropylene glyceryl ether and poly (ethylene glycol) distearate into PP does not substantially affect the tensile strength of the plastic, meaning that the polymer matrix of PP still remains intact as its original state without said incorporation.

Impact Strength Test Result of Germ Repellent PP

As in Example 1, Izod impact strength was characterized by Kunlun impact tester according to ASTM D256-10 with impact energy 5.5 J.

TABLE 8

| | Impact strength (J/m) | |
|---|---|---|
| | Comparative plastic | |
| Sample name | (Control) | Germ-repellent plastic (B1) |
| 1 | 655.5 | 712.9 |
| 2 | 659.9 | 710.1 |
| 3 | 671.4 | 728.9 |
| 4 | 640.5 | 749.7 |
| 5 | 669.1 | 702.8 |
| Avg. | 659.3 | 720.9 (+9.3%) |

From the results of Table 8, the incorporation of 0.56 wt. % of polyoxypropylene glyceryl ether and poly (ethylene glycol) distearate into PP have some positive effect on impact strength of the plastic (increased by 9.3% as compared to PP without said incorporation), meaning that the polymer matrix of PP still remains intact as its original state without said incorporation, and the incorporation of the anti-biofouling agent even can improve its impact strength, depending on the right selection of the anti-biofouling agent.

Similar to the Izor impact test (according to ASTM D256-10) on sample B1, sample B2 fabricated into bottle cap form is also subject to the same test, and a plain PPIC plastic is used as a control. The result shows that the difference in impact strength between sample B2 and the plain PPIC (control) is about +9.3% (70.95 kJ/m³ vs 64.89 kJ/m³).

Lid made by germ repellent plastic (B1) is also subject to the tensile strength test. The tensile strength (according to ASTM D638-10) of the germ-repellent plastic B1 is 31.94 Mpa, as compared to the comparative plastic Control, which is 32.1 Mpa. It indicates a decrease of 0.5%. Furthermore, when germ repellent plastic B1 vs. Control is tested, it shows an increased impact strength (according to ASTM D256-10) of 8.5%.

### Example 3—Germ Repellent Silicone Rubbers

The germ repellent silicone rubber (C1) is prepared containing 100 g of silicone rubber and 1.07 g of poly (ethylene glycol) dimethicone anti-biofouling compound and 0.13 g of fumed silica, which mixed on a two-roll mill. The preparation of germ repellent silicone sheet sample comprises vulcanization and post-vulcanization. The former step (vulcanization) is completed by compression molding under 180° C. for 200 seconds, while the latter step (post-vulcanization) is achieved by treatment of compressed sample at 200° C. in an oven for at least 4 hours in the presence of inorganic fillers such as silica.

In a prior US patent application (publication number US20200017658) by the same applicant, it was concluded that only liquid silicone rubber (LSR) could be modified by some other anti-biofouling agents to have a satisfactory germ repellency, instead of using poly (ethylene glycol) dimethicone to modify high consistent rubber (HCR). In contrast, the present invention is capable to modify HCR using the following exemplary anti-biofouling agent, polyethylene glycol 12 (PEG 12) dimethicone (“OFX0193”), in the presence of silica particles so that during processing the silicone rubber and the anti-biofouling agents can withstand at 200° C. in order to achieve a satisfactory germ repellency while other mechanical properties of the germ-repellent silicone rubber of the present invention remains substantially unchanged after the processing.

Comparative silicone rubber samples (Control) containing only the basic material (silicone rubber) is also prepared in an identical manner, except that no filler, or anti-biofouling compound is included.

A swab test (described hereinbefore) was conducted to compare germ-repellency of the germ-repellent plastic sample (C1) with that of the comparative plastic samples (Control). The results on the reduction of colony formation units of E. coli and S. aureus on the lid samples made by different plastics are shown in Table 9.

Other than sample C1, silicone rubber, especially HCR, is also incorporated with other possible anti-biofouling agents compatible to the HCR including trimethoxysilyl propoxy polyethylene oxidemethyl ether (“Gelest SIT8408.0”), and polyethylene glycol 400 distearate (“HallStar® PEG 400 DS”), to obtain other germ-repellent silicone rubber samples C2 to C5. These germ-repellent silicone rubbers are also subject to the swab test to demonstrate their germ repellency against S. aureus and E. coli.

TABLE 9

| Sample | Anti-biofouling agents with other | | |
|---|---|---|---|
| Name | additives (if any), and their ratio | S. auerus | E. coli |
| C1 | 1.2 phr (OFX-0193:AEROSIL ® 200 | 99.9% | 99.9% |
| | Pharma = 8:1) | | |
| C2 | 1.5 phr PEG 400 Distearate | 99.9% | 99.9% |
| C3 | 1 phr Gelest SIT8408.0 | 99.9% | 99.9% |
| C4 | 1.05 phr (PEG 400 DS:AEROSIL ® | 99.9% | 99.9% |
| | 200 Pharma = 6:1) | | |
| C5 | 1.2 phr (OFX-0193:AEROSIL ® 200 | 99.9% | 99.9% |
| | Pharma = 8:1) | | |

As can be seen in Table 9, all germ-repellent silicone rubber samples (C1 to C5) of the present invention provides above 99.9% reduction of both E. coli and S. aureus in the swab test as compared to the comparative sample (Control). Moreover, the sheet made of germ-repellent silicone rubber C1 passed the Council of Europe Resolution AP (2004) 5 (silicone rubber-overall migration), US FDA 21 CFR 177.1210 (closure with sealing gaskets), US FDA 21 CFR 177.2600 (rubber articles) food contact safety test, and France regulations (French Arrete du 25 Nov. 1992, Annex III No. 2—with reference to European Pharmacopoeia, 2005; analysis by ICP). Furthermore, germ-repellent silicone rubber C1 also passed LFGB sensorial examination—odor and taste test.

Tensile Strength Test Result of Germ Repellent Silicone

As in Example 1, ASTM D638-10 Type VI specimens of silicone and germ repellent silicone were prepared by Dumbbell Cutter and tested by MTS under speed of 10 mm/min.

TABLE 10

| | Tensile strength (Mpa) | |
|---|---|---|
| | Comparative silicone | Germ-repellent silicone |
| Sample name | rubber (Control) | rubber (C1) |
| 1 | 10.8 | 10.4 |
| 2 | 10.2 | 11.2 |
| 3 | 10.5 | 10.3 |
| 4 | 10.2 | 10.7 |
| 5 | 10.9 | 10.4 |
| Avg. | 10.5 | 10.6 (+0.9%) |

From the results of Table 10, the incorporation of 1.07 wt. % of poly (ethylene glycol) dimethicone into silicone does not substantially affect the tensile strength of the plastic, meaning that the polymer matrix of silicone still remains intact as its original state without said incorporation.

Furthermore, the tensile strength (according to ASTM D638-10) of the germ-repellent silicone rubber C1 is 10.89 Mpa, as compared to the comparative plastic Control which is 10.57 Mpa which indicates an increase of 2.9%.

Hardness Test Result of Germ Repellent Silicone

Shore A hardness was characterized by Phase II PHT-950 Digital Shore A Durometer according to ASTM D2240-04. The test specimen with a thickness of 6.4 mm is placed on a hard flat surface. The indenter for the Durometer is pressed into the specimen, which is parallel to the surface of the specimen. The hardness is read within one second (or as specified by the customer) of firm contact with the specimen.

TABLE 11

| | Hardness (Shore A) | |
|---|---|---|
| | Comparative silicone | Germ-repellent silicone |
| Sample name | rubber (Control) | rubber (C1) |
| 1 | 54.8 | 58.9 |
| 2 | 54.7 | 57.0 |
| 3 | 56.4 | 59.1 |
| 4 | 55.5 | 59.3 |
| 5 | 56.0 | 56.6 |
| Avg. | 55.5 | 58.2 (+2.7) |

From the results of Table 11, the incorporation of 1.07 wt. % of poly (ethylene glycol) dimethicone into silicone does not substantially affect the hardness of the plastic, meaning that the polymer matrix of silicone still remains intact as its original state without said incorporation.

Samples C2-05 are also subject to same Shore A hardness test, and the result is summarized as follows:

TABLE 12

| Sample Name | Shore A Hardness |
|---|---|
| C2 | 44.5 |
| C3 | 46.1 |
| C4 | 45.5 |
| C5 | 50.6 |

Overall, there is less than 10% change in transmittance, tensile strength, impact strength and heat deflection temperature relatively observed in the articles made by the food contact safe, germ repellent material of the present invention as compared to those made of the corresponding virgin material. According to some supplementary evaluation reports, for seal ring and nozzle material used in drinking bottle, the hardness and tensile strength changed less than 10% as compared to the virgin material.

### INDUSTRIAL APPLICABILITY

The present invention is applicable in containers and processors for food processing, consumption, transportation and storage, which is required to maintain certain mechanical properties after imparting germ repellency while no harmful constituents are released from the plastic, and comply with major regulations of food contact articles or materials in the world.

1. A food contact safe, germ repellent material selected from a thermoplastic or an elastomer, the material comprising:
one or more anti-biofouling agents at approximately 0.1 to 20 wt. % to the total weight of the thermoplastic or the elastomer; and
one or more components of fillers, carrier agent, mold releasing agent, curing agent, and/or oil, at approximately 0.1 to 2 wt. % for each or more of the components to the total weight of the thermoplastic or the elastomer,
the anti-biofouling agents forming a hydration layer on the thermoplastic or elastomer imparting germ repellency of at least 92.1% against bacteria including Escherichia coli and Staphylococcus aureus while optical and mechanical properties including transmittance, tensile strength, impact strength, hardness, and/or heat deflection temperature of the material is/are changed by less than 10% after being associated with the one or more anti-biofouling agents and the one or more of the components other than the anti-biofouling agent.

2. The material of claim 1, wherein the thermoplastic is selected from modified polycyclohexylenedimethylene terephthalate or polypropylene, and copolymer thereof.

3. The material of claim 2, wherein the one or more anti-biofouling agents is/are selected from polyol and derivatives thereof.

4. The material of claim 2, wherein the copolymer of polypropylene comprises polypropylene impact copolymer.

5. The material of claim 3, wherein the one or more anti-biofouling agents is/are at approximately 0.1 to 10 wt. %.

6. The material of claim 3, wherein the polyol and derivatives thereof include polyethylene glycol sorbitan monolaurate, polyethylene glycol sorbitan monooleate, poly(ethylene glycol) sorbitol hexaoleate, ceteareth-20, poly (ethylene glycol) distearate, poly (ethylene glycol) dimethicone, poly(ethylene oxide)-poly(propylene oxide)-poly(ethylene oxide), poly(ethylene glycol)-block-poly(propylene glycol)-block-poly(ethylene glycol), and alkyl polyglycol ether.

7. The material of claim 2, wherein the fillers are reinforcing fillers comprising one or more types of nano-sized inorganic particles.

8. The material of claim 7, wherein the inorganic particles are at approximately 0.1 to 1 wt. %.

9. The material of claim 7, wherein the inorganic particles include fumed silica treated with any one of hexamethyldisilazane, dimethylpolysiloxane, and polydimethylsiloxane.

10. The material of claim 2, wherein the carrier agent is represented by the following formula: 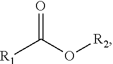
wherein R₁ and R₂ are independently hydrocarbon moieties and each of the hydrocarbon moieties comprises about 10 to 30 carbon atoms with linear or branched chain.

11. The material of claim 10, wherein the carrier agent is at approximately 0.1 to 1 wt. %.

12. The material of claim 10, wherein the carrier agent comprises stearyl palmitate, stearyl behenate, stearyl stearate, palmityl palmitate, myristyl palmitate, and myristyl myristate.

13. The material of claim 1, wherein the elastomer is high consistency rubber.

14. The material of claim 13, wherein the fillers comprise silica.

15. The material of claim 13, wherein the oil is silicone oil including hydroxyl silicone oil.

16. The material of claim 13, wherein the one or more anti-biofouling agents comprise one or more polyethylene glycol and fatty acid moieties.

17. The material of claim 16, wherein the one or more anti-biofouling agents comprise polyethylene glycol fatty acid ester, polyoxyethylene lauryl ether, polyethylene glycol dimethicone, trimethoxysilyl propoxy polyethylene oxide methyl ether, and polyethylene glycol di stearate.

18. The material of claim 13, wherein the curing agent comprises 2,4-dichlorobenzoyl peroxide and di-tert-butyl 1,1,4,4-tetramethyltetramethylene diperoxide.

19. (canceled)

20. A method for preparing the material of claim 1 comprising:
preparing the masterbatch of anti-biofouling agents by comingling the thermoplastics with anti-biofouling agents, one or more components of fillers, carrier agent, mold releasing agent, curing agent, and/or oil at approximately 0.1 to 2 wt. % in a twin-screw extrusion process;
adding the masterbatch into one of the thermoplastics at 1 to 25 wt. % for molding,
wherein the thermoplastics comingled with the antibiofouling agents are selected from modified polycyclohexylenedimethylene terephthalate or polypropylene.

21. A method for preparing the material of claim 13 comprising:
mixing raw silicone rubber, the one or more anti-biofouling agents, the fillers and carrier agent in a two-roll mill to form a mixture;
compression molding the mixture for vulcanization to obtain a vulcanized silicone rubber;
heating the vulcanized silicone rubber in an oven for post-vulcanization to obtain the elastomer.
